(19) United States
(12) Patent Application Publication
(10) Pub. No.: US 2019/0294942 A1
(43) Pub. Date: Sep. 26, 2019

(54) DEVICE COMPRISING RFID TAGS FOR MONITORING STORAGE AND/OR TRANSPORT CONDITIONS OF ARTICLES AND ASSOCIATED METHODS

(71) Applicants: UNIVERSITE DE MONTPELLIER, Montpellier (FR); CENTRE NATIONAL DE LA RECHERCHE SCIENTIFIQUE (CNRS), Paris (FR)

(72) Inventors: Brice SORLI, Montagnac (FR); Arnaud VENA, Saint Mathieu De Treviers (FR)

(73) Assignees: UNIVERSITE DE MONTPELLIER, Montpellier (FR); CENTRE NATIONAL DE LA RECHERCHE SCIENTIFIQUE (CNRS), Paris (FR)

(21) Appl. No.: 16/464,137

(22) PCT Filed: Nov. 24, 2017
(86) PCT No.: PCT/EP2017/080405

§ 371 Date: May 24, 2019

(30) Foreign Application Priority Data
Nov. 25, 2016 (FR) 1661534

(51) Int. Cl. G06K 19/07; G06K 19/077; H01Q 1/22

(52) U.S. Cl. CPC G06K 19/0717; H01Q 1/2208; G06K 19/07773; G06K 19/0726

(57) ABSTRACT

An assembly that includes a plurality of articles, passive or semi-passive RFID tags arranged on the articles, each including at least one unique identifier, in particular recorded in a non-rewritable memory, the tag being configured to transmit, when interrogated, at least the unique identifier of the tag, and a hub including at least one RFID reader, present within the articles, with articles arranged on either side of the hub along at least two directions of an orthonormal reference frame associated with the hub, the latter being arranged in such a way as to be able, by at least one reading antenna, to interrogate at least the RFID tags of articles arranged in said directions, the hub being configured to receive data from the interrogated RFID tags.

The present invention relates to methods and devices for monitoring conditions of storage and/or transport to which articles are exposed.

Certain articles, such as medicines or perishable food products, during transport from their site of manufacture to the site of distribution, must be maintained under predefined environmental conditions, specifically temperature conditions, in order to prevent any deterioration.

It has been proposed that thermometers should be arranged in the center of packages containing articles. In the event of a temperature deviation outside a predefined range, the package is considered as potentially defective, and must be discarded accordingly, with an evident risk of wastage, if only a proportion of articles are actually affected.

Moreover, this solution does not permit the detection of any attempted substitution of articles with other articles.

CN102005020 discloses a system for monitoring compliance with the cold chain for medicines, by the fitting of RFID tags to the packaging thereof. The reader is arranged on the transport vehicle, and not directly on the palletized unit.

Publication WO 2015/067992 discloses a system for the real-time recording of conditions for the transport of articles, using a “black box” which travels with said articles and is capable of recording environmental parameters. The system is designed for the unique identification of each article which travels with the black box, for example by means of a QR code or a RFID tag, and for the recording of corresponding identifiers in a memory of the black box, prior to the transport of articles. Upon arrival at the destination, the memory of the black box can be scanned in order to retrieve saved values for the movement of certain parameters, and to confirm that the identifiers memorized correspond to the articles present. The use of a single black box for a series of articles raises the above-mentioned issue of the absence of any grading of measurement. Moreover, the system is not entirely effective vis-á-vis the coverage of all articles transported.

US 2006/0086809 describes a system for the reading of RFID tags on stacked objects, using a reader arranged externally to the stack of objects. Waveguides are arranged between objects in order to facilitate this reading. An arrangement of this type is relatively complex, and is not compatible with conventional packaging methods.

U.S. Pat. No. 8,068,031 discloses specific arrangements of antennae for RFID tags, which are designed to permit the reading of stacked articles.

US2009/0303052 discloses a system of “CCDMUs” or “Container Control Device Monitoring Units” fitted to boxes on a pallet, and to the pallet itself, with communication between the CCDMU on the pallet, which is equipped with a display, and those on the boxes. Each CCDMU is relatively complex and cumbersome, thereby limiting the achievable grading of measurement associated with such a system, the cost of which is also relatively high. Moreover, the electric power supply for CCDMUs may pose a problem, in terms of independence.

Patent application US 2013/214989 describes an integrated system in a container for the tracking of articles which carry RFID tags, wherein the container additionally comprises a detection module, to which an antenna is fitted, and, coupled to the detection module, a tracking unit, for the processing of information obtained from the tags which are fitted to articles and the communication thereof to external terminals.

Patent application US 2011/125663 discloses a tracking system which involves communication between tags which are carried by articles transported or stored in a vehicle and a master unit which is arranged in the vehicle, or externally to the latter, for example associated with a pallet of articles which is present in the vehicle. The tags can incorporate various sensors, from which information is transmitted to the master unit.

There is a requirement for the further improvement of methods and devices for the monitoring of articles during the packaging, transport and/or storage thereof and, more specifically but not exclusively, of environmental conditions to which said articles may be exposed during the packaging, transport and/or storage thereof.

The invention is intended to fulfil this requirement, and does so, according to a first of its aspects, by means of an assembly comprising:
a plurality of articles,
passive or semi-passive RFID tags arranged on the articles, each comprising at least one unique identifier, in particular recorded in a non-rewritable memory, the tag being configured to transmit, when interrogated, at least the unique identifier of the tag,
a hub comprising at least one RFID reader, present within the articles, with articles arranged on either side of the hub along at least one direction of an orthonormal reference frame associated with the hub, the latter being arranged in such a way as to be able, by means of at least one reading antenna, to interrogate at least the RFID tags of articles arranged in said direction, the hub being configured to receive data from the interrogated RFID tags.

The invention, if desired, permits the completion of an inventory of articles arranged around the hub.

The RFID reader preferably comprises a plurality of antennae, which are differentially oriented, in order to facilitate the reading of labels arranged in a number of directions on said orthonormal reference frame.

The tags are preferably configured to transmit, when interrogated by the hub, data other than their identifier, specifically informative data on at least one environmental parameter relating to the tag.

The invention thus permits the measurement, with a relatively fine grading if desired, of said environmental parameter, and consequently the more accurate identification of the article or articles exposed to undesirable conditions.

For example, the tags each comprise a sensor, or are each connected to a sensor and, when the labels are interrogated by the hub, they transmit data associated with the sensor environment to the latter. As a variant, the tags comprise antennae, which are functionalized to respond in a predefined manner to an environmental parameter; the hub, as a function of the response from the antenna of the tag, when the latter is interrogated, can retrieve information associated with the environment of the tag.

The environmental parameter is preferably selected from temperature, humidity, acceleration, orientation, pressure, impacts, exposure to oxygen, the presence of a given gas, the presence of a given analyte, exposure to light, exposure to radiation, specifically UV, IR or ionizing radiation, wherein the parameter is preferably temperature, impacts or humidity.

Preferably, each article is fitted with a tag, all the tags are identical and are equipped with an identical sensor for the environmental parameter. As a variant, it is possible, specifically for reasons of cost, to arrange within the assembly according to the invention tags with no sensor and tags with a sensor, wherein the latter are distributed in a predefined manner within the assembly in order to allow the environmental parameter to be read with the most accurate grading possible. For example, tags fitted with sensors are arranged at a regular pitch on the periphery of the assembly and in the center of the assembly.

Tags may be passive, i.e. with no internal or external energy source, other than the radiofrequency energy transmitted by the hub.

As a variant, the tags are semi-passive, i.e. they incorporate an internal energy source, such as a battery or an accumulator, which permits, for example, an increase in the reading distance and/or the memorization of data. The energy source may be of the printed battery type, where applicable. A semi-passive tag has access to the additional energy delivered by an internal energy source, in order to respond to the hub.

The tags incorporate, for example, a flexible adhesive base medium, which is adhered to the article. As a variant, tags are encapsulated in a substrate, which may be rigid, semi-rigid or flexible.

The RFID reader of the hub may be compliant with EN standard 302-208. Preferably, the antenna or antennae of the RFID reader of the hub have a bandwidth which can encompass frequencies of 860-960 MHz. Communication between the reader and the tags may be executed in accordance with ISO standard 18000.

The hub preferably incorporates an on-board energy source which is appropriate to the duration of the monitoring of articles; this may be an accumulator with an independent capacity of at least one week. The hub may incorporate an on-board device for the local production of energy, e.g. by the conversion of movements of the assembly according to the invention into electrical energy. The format of the unique identifier of tags may be the EPC (Electronic Product Code) 6. The EPC class concerned may be class 1, 2 or 3.

Preferably, the hub is configured for the remote transmission of information associated with data received from interrogated tags. As a variant, or additionally, these data are memorized in the hub.

Data transmitted remotely by the hub may include an alert pertaining to the inventory of articles and/or the variation of at least one environmental parameter.

In one variant, or in combination, the hub may be configured for storing in the tags information associated with data received, specifically at least one item of information associated with the environment of the latter, specifically the variation of at least one environmental parameter. The hub may be configured to select tags according to their unique identifiers, in order to permit the logging of those in which the representative data for at least one environmental parameter have breached a predefined threshold, i.e. are measured as higher or lower than a predefined threshold value. The hub may be configured to record information associated with the environmental parameter in tags, the representative data for at least one environmental parameter of which have breached a predefined threshold. This permits the execution of the highly accurate tracking of articles, wherein the tag remains on the article, and thus the tracking of information indicating an anomaly. This permits the acquisition of information on articles, independently of any connection to the hub, or to a remote base to which the hub has transmitted data.

Information may be recorded in a memory zone of the tag, which is accessible in write mode. This memory zone may then be switched to write-protect mode, and is thus no longer accessible, thereby permitting the indication of an anomaly and rendering the data thus recorded incorruptible.

Information may be recorded in the form of a code indicating that the representative data for an environmental parameter have breached the predefined threshold, for example a binary value of 0 or 1, wherein the code can additionally contain a value corresponding to a duration of the overshoot of the predefined threshold value by the representative data for the environmental parameter. A correlation table between durations of exposure and code values may be employed. Information indicating that, conversely, no anomaly has been detected, can be stored in the same memory zone of the tags of articles, the environmental parameter of which has not exceeded the predefined threshold, preferably again in the form of a code.

An external reader may be employed, upon the reception of articles, for the reading of labels by means of a dedicated application and the retrieval of recorded information, where applicable, in order to confirm the integrity of each article upon receipt. For example, in the event of an excessively high temperature deviation in one or more articles, information stored in the tags concerned permits the removal of these articles from the batch, and the elimination of any risk of the use of impaired goods.

The assembly advantageously comprises means for the packaging of the plurality of articles, together with the hub, for example a film wrap, a cardboard box, a timber, plastic or metal casing, a container or a bag.

The assembly may be arranged on a pallet, specifically a pallet which is compliant with ISO standard 6780: 2003.

Each article may be comprised of one object or a plurality of objects which are packaged together by means of secondary packaging. In this case, a single tag may be provided per secondary package, provided that this is sufficient vis-á-vis the monitoring envisaged.

The assembly according to the invention may further be contained in an enclosure, for example a temperature-controlled enclosure, such as a cold room or a refrigerator.

Articles arranged around the hub may be contiguous or otherwise. They are preferably stacked in a number of back-to-back tiers, each a number of articles high, wherein this is only one example, among others, of the arrangement of articles around the hub. According to one variant, the articles are arranged in bulk around the hub.

Articles include, for example, medicines, vaccines, punnets of fruit, fresh products including fish, meat or sandwiches and, more generally, any articles which are sensitive to an environmental parameter such as temperature, specifically perishable goods.

Articles may also be objects which are susceptible to theft, counterfeiting or smuggling, such as cigarettes or alcohol, spare parts, industrial components, luxury products, IT or telephone hardware.

The hub may be packaged together with articles arranged on either side of the latter in at least two directions, preferably three directions of the above-mentioned orthonormal reference frame, wherein the hub is preferably situated in the center of the plurality of articles.

The hub is preferably arranged in the center of the assembly, with, for example, in one direction D, a number n₊ of articles arranged on one side of the hub in the direction D which substantially corresponds to the number n₋ of articles arranged in the direction D on the opposing side; for example, abs(n₊-n₋)/n₊ ranges from 0 to 0.3, preferably from 0 to 0.2. The direction D preferably corresponds to one of the axes X, Y or Z of the above-mentioned orthonormal reference frame.

The hub may be of identical dimensions to the articles, or a multiple thereof, in order to permit the stacking of the hub together with the articles.

The hub may be configured to activate the automatic reading of labels in response to a predefined event. This event, for example, may be selected from: a movement of the packaging means, the reception of a command signal or a geolocation signal, or the reception of a clock signal. Specifically, in one example, the hub activates a reading of labels upon the detection of its presence in a predefined zone.

The hub may comprise at least one sensor for an environmental parameter, a receiver for a geolocation signal, specifically a GPS signal, a means of communication via a mobile telephone network, for example GSM, or a network of connected objects, for example SIGFOX or LORA. Preferably, the hub is also configured to permit the establishment of a connection with a local network, for example via a link of WiFi, Bluetooth, or LiFi type. This may permit a user to connect directly to the hub, for the purposes of the configuration thereof and/or for the reception of data stored in the latter.

The hub may be designed to interrogate the RFID tags in a periodic manner, for example at regular intervals, for example at intervals between 1 second and 24 hours, preferably between 60 seconds and 3 hours, or further preferably between 60 seconds and 60 minutes. The measurement interval is preferably parameterizable by the user.

As indicated above, the hub advantageously comprises at least one RFID reader having a plurality of antennae, specifically of the UHF type.

Where the hub comprises a plurality of antennae, the latter can be connected to a RFID reader via a RF (radiofrequency) multiplexer.

The antennae may be arranged on the sides of a housing of a generally parallelepipedic design, and the hub preferably comprises six antennae, arranged respectively on the six sides. Each of the antennae may be planar, and the antennae preferably incorporate an element of directionality, wherein they are designed to permit the location by the hub of articles within the assembly by pseudo-triangulation, as detailed hereinafter.

The hub is preferably designed to record all or part of the data transmitted by the RFID tags. This recording may be executed in a non-volatile memory. The hub preferably incorporates a slot for the accommodation of a memory card, for example of the micro-SD type, and data may be recorded on this memory card. As a variant, or additionally, the hub may comprise a hard disk, for example of the SSD type. Data recorded, in addition to the tag identifiers and the corresponding environmental data transmitted by the latter, may include data originating from the hub itself, including its position, the date, time, temperature, humidity, pressure, acceleration, etc.

The RFID tags are preferably UHF tags, each of which preferably has a dipole antenna.

A further object of the invention is a method for monitoring conditions of storage and/or transport to which articles in an assembly according to the invention are exposed, as defined above, wherein the RFID tags are interrogated by means of said hub.

Specifically, tags can be interrogated for the retrieval of information associated with the observation of at least one environmental parameter by the sensors associated with said tags, specifically temperature. Preferably, the hub automatically identifies tags in the assembly before, during and/or after the packaging of the assembly by a packaging means.

It is possible to proceed such that, if desired, the hub automatically initiates an operating mode which is selected from a number thereof, according to its location.

The hub can be configured to operate in accordance with a number of predefined and preprogrammed operating modes. Selection of an operating mode may be executed by an operator or, as a variant, may be executed automatically, according to the type of goods to be monitored. This permits the provision of a multifunctional hub, which can be used for a wide variety of articles, and wherein the setting of parameters by the operator is simplified. The hub can be configured to permit selection between these operating modes, by means of instructions which are transmitted in a wired or wireless arrangement.

One operating mode of the hub may involve the monitoring of a predefined parameter and the recording, for example at regular intervals, of a value for this parameter for each of the tags. For example, temperature is recorded for all articles at regular intervals. This permits the identification of articles which are unfit for use on the grounds of non-compliance with conditions for storage and/or transport.

The hub may store, in the tags, information associated with data received further to interrogation, specifically at least one item of information associated with the monitoring of a predefined parameter, specifically the variation of at least one environmental parameter. The hub can select tags according to their unique identifiers, in order to log those in which the representative data for at least one environmental parameter has breached a predefined threshold, i.e. is measured as higher or lower than a predefined threshold. The hub can record information associated with the environmental parameter in tags, the representative data for at least one environmental parameter of which has breached a predefined threshold. The hub can record information on the fly, further to the interrogation of each tag, or only once all the tags have been interrogated.

Information may be recorded in the form of a code indicating that the representative data for an environmental parameter has breached the predefined threshold, for example a binary value of 0 or 1, wherein the code can additionally contain a value corresponding to a duration of the overshoot of the predefined threshold value by the representative data for the environmental parameter. A correlation table between durations of exposure and code values may be employed.

The hub can record information indicating that, conversely, no anomaly has been detected in the same memory zone of the tags of articles, the environmental parameter of which has not exceeded the predefined threshold, preferably in the form of a code.

Another operating mode of the hub may involve the monitoring of the presence of articles, for example at regular intervals, for the purposes of the completion of an inventory. This permits the monitoring of goods, e.g. for the detection of theft. The hub can transmit and/or store an alert on a tag, where it loses contact with an article for a predefined period, thereby compromising the integrity of said article.

The two operating modes are not mutually exclusive, and can co-exist.

The frequency of monitoring can vary, where applicable; for example, monitoring is executed at a default time interval, and is executed at a greater frequency where a predefined condition is fulfilled, for example the breach of a threshold by an environmental parameter, the reception of a command signal to this effect, or the detection of presence in a predefined geographical zone. For example, during the transit of goods, one or more zones of increased risk can be identified, during which the more active execution of monitoring is required. Operating modes may be selected, for example, in accordance with the type of articles. To this end, tag identifiers may be selected such that they provide an indication of the nature of the corresponding articles. For example, identifiers commencing with one digit may correspond to one type of articles, and others commencing with another digit may correspond to another type of articles.

The hub may be configured to respond to an anomaly observed in an article, for example an overshoot of a threshold value for a parameter, for example the deviation of the measured temperature beyond a predefined range. This may also include the failure of a tag to respond to an interrogation.

The hub can be configured to transmit a message upon the detection of an anomaly, via a telecommunications network, for example by the submission of a SMS message. The message transmitted may include the identifier for the tag corresponding to the article, together with the nature of the anomaly. Where applicable, the hub is parameterizable for the definition of actions to be executed as a function of the nature of the anomaly concerned. For example, an anomaly entailing the risk of the loss of all the articles, for example a rapid rise in temperature, may result in actions which differ from those engendered by the failure of a tag to respond to an interrogation concerning the latter.

According to another of its aspects, the invention further relates to a packaging method for the constitution of an assembly according to the invention, as defined above, comprising the following steps:
the stacking of a plurality of articles, each of which carries a RFID tag, each incorporating a unique identifier in its memory,
the provision within the plurality of articles, specifically at the center thereof, of a hub incorporating a RFID reader which is configured to read the tags on the stacked articles.

The hub may incorporate, it its memory, an information file on the position of articles within the assembly, together with identifiers for the corresponding tags; the hub is thus aware of the position of the article associated with each tag interrogated.

The stack of articles may be constructed in a predefined manner, which corresponds to the file.

As a variant, the hub is not aware in advance of the identifiers of articles according to their position within the assembly, and this information is only transmitted to the hub during, or upon the completion of the packaging process, for example once all the articles are in place. For example, a file containing the identifiers for tags, according to the position of the corresponding articles, is transmitted to the hub once all the articles are in place.

As a further variant, during the construction of the stack, the hub receives information by way of notification of the identifier for the tag of the article which is in the course of positioning, together with its location within the assembly, where applicable.

It is also possible for the hub to be configured such that it independently determines, for example by the use of a plurality of antennae, the location of a tag and of the associated article within the stack, by pseudo-triangulation. Specifically, the hub may be provided with a plurality of antennae, which it is capable of selecting. Each antenna covers at least a proportion of all the articles, and each tag generates a response signal, which is dependent upon its relative positioning in relation to the antenna employed. By interrogating the same tag with different antennae in succession, it is possible to locate the tag relatively to the hub. Preferably, for this purpose, the hub has at least three antennae, and preferably at least six antennae, directed in different directions.

The hub may be designed for the automatic execution of an inventory, by establishing the identifiers of tags arranged within its reading field, together with the position of the corresponding articles. This inventory may be completed upon the constitution of the assembly, for example in the factory, or at the destination, for example during the unpacking and sampling of articles. The inventory may also be completed during transport or storage, specifically for the detection of theft or of any attempt to substitute articles with other articles.

The hub may be designed to trigger an alert relating to the environment of articles, for example the overshoot of a threshold value for an environmental parameter by at least one of the articles, for example by calling up a 3D display of all the articles, with the articles concerned indicated by a predefined mode of representation, for example a change of color and/or a flashing image. This may facilitate the understanding by an operator of the issue responsible for the overshoot of the threshold, together with the physical identification of the article or articles concerned, for example for the purposes of the removal thereof.

The hub may also be designed to generate an alert signal where it is unable to interrogate all the tags for articles which are presumed to be present within its field of surveillance. For example, the hub is designed, on request, at regular intervals, or in response to a predefined event, to compare the result of a new inventory with that of an inventory completed previously, and to flag up the missing tag or tags.

The hub, specifically in the presence of semi-passive tags, may be designed, in common with the latter, to permit data exchanges between the hub and the tags, in order to modify the manner in which the latter operate, and specifically for the reprogramming thereof. For example, the tags store the measurement results for at least one environmental parameter, in the manner of a “data logger”, and the hub may instruct the transfer of data memorized in the tag to the hub. Once this transfer has been executed, previous data may be erased from the memory of the tag. This permits the periodic saving of data stored by the tag, and the re-writing of new values in the memory of the tag; where applicable, the hub resets the memory of the tag immediately the transfer is completed.

It is also possible to configure the hub such that it detects the fulfilment of a predefined condition and, where this is the case, delivers an instruction to the tags concerning, for example, the frequency and/or resolution of measurement of at least one environmental parameter. For example, if the hub detects a departure from a predefined temperature range, it instructs the tags to record the temperature measured locally by each tag at a higher frequency. Where the hub detects that it lies within the normal temperature range, the frequency of measurement is lower, thus permitting, for example, the restriction of data exchanges between the hub and the tags, thereby saving energy.

In one example, the instruction submitted to the tags in the event of a departure from a predefined range of an environmental parameter which is measured by the hub is an instruction requesting that the tag time stamp the executed measurements.

In a further example of deployment, the hub does not download measurement data recorded by the tags, but simply logs the location of tags relatively to the hub, and confirms their presence. The integrity of goods transported is ensured accordingly. Data concerning conditions of transfer may be consulted upon the reception of goods, by the interrogation of tags.

Understanding of the invention will be clarified by the following detailed description of non-limiting examples of embodiment of the latter, and by the examination of the attached drawing, in which:

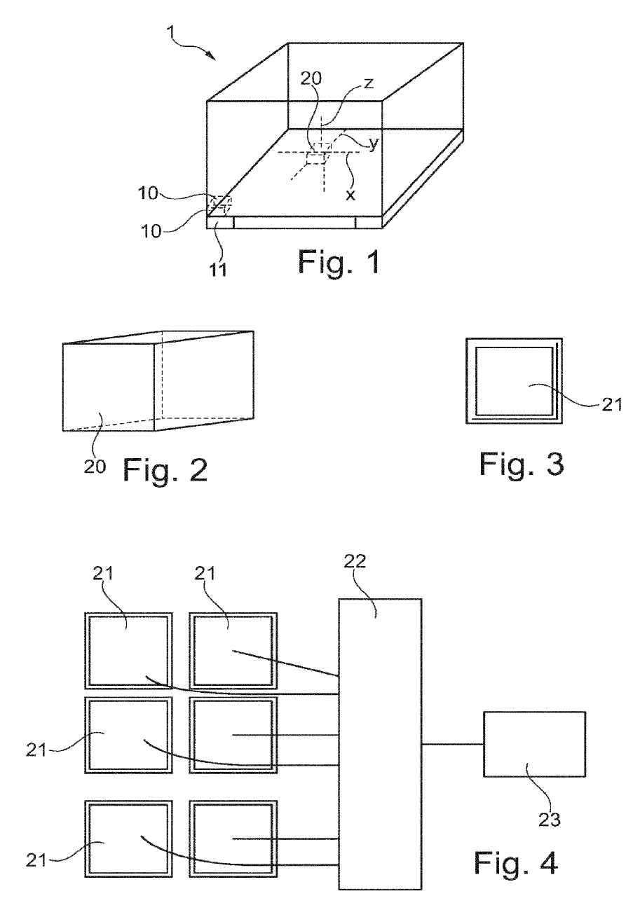

FIG. 1 shows a schematic and partial representation of an assembly comprising a plurality of articles and a hub according to the invention,

FIG. 2 shows a separate partial and schematic representation of the hub in FIG. 1,

FIG. 3 shows a front view of an antenna of the hub,

FIG. 4 illustrates the connection of antennae of the hub,

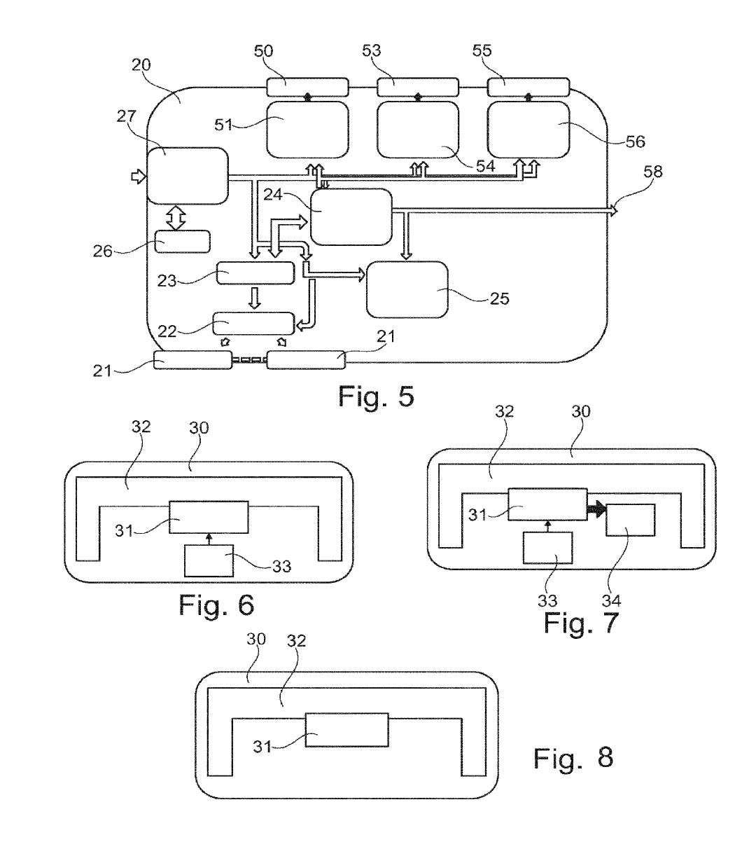

FIG. 5 shows a block diagram illustrating exchanges of data and energy between the various constituent elements of the hub represented in FIG. 1,

FIG. 6 shows an example of a RFID tag fitted to articles which are arranged within the reading field of the hub,

FIGS. 7 and 8, in analogous views to FIG. 6, show variants of the embodiment of tags.

FIG. 1 represents an assembly 1 according to the invention, comprising a plurality of articles 10, only two of which are represented by broken lines, and a hub 20 executed according to the invention.

The articles 10 are, for example, boxes, each of an essentially parallelepipedic shape, stacked in three directions X, Y and Z of an orthonormal reference frame associated with the hubs 20.

The articles 10 are stacked, for example, on a pallet 11, preferably of a standardized format.

Articles 10 may be contained in a timber or cardboard box arranged on the pallet 14 or, as a variant, may be covered by a film wrap, for example a thermo-shrink film, in order to maintain the cohesion of the stack during the transport and handling of the pallet 11.

According to one aspect of the invention, the hub 20 is preferably arranged substantially in the center of the stack of articles 10, i.e. articles 10 are arranged on either side of the hub 20 in each of the directions X, Y and Z.

An exemplary hub 20 is represented in FIG. 2.

Preferably, the latter assumes a generally parallelepipedic shape, advantageously of the same format as the articles 10, or to multiple format of the dimensions of one article 10, such that the hub 20 can be easily incorporated into the stack of articles 10 without creating an offset in any of the directions X, Y and Z. As a variant, the hub 20 has dimensions which are smaller than or equal to the volume of one article 10.

The hub 20 may be provided, on each of its six sides, with an antenna 21, which is represented schematically in FIG. 3, wherein the antennae 21 are connected by a multiplexer 22 to the remainder of the electronic circuit of a RFID reader 23, as illustrated in FIGS. 4 and 5. The reader 23 permits the interrogation of RFID tags 30 which are present on all or some of the articles 10 and, where the latter are passive, supplies all the energy which is required for their operation.

The hub 20, in addition to the RFID reader 23, comprises a central processing unit 24 which manages the operation of the various elements of the hub 20, wherein this central unit has a memory 25 in which various information may be stored, as detailed hereinafter. The memory 25 may be constituted, at least in part, by a memory card, for example of the micro-SD type.

The hub 20 is also provided with a battery 26 and a power supply management module 27 which permits the recharging of the battery 26, via a cable or by induction.

The hub 20 may also be equipped with a satellite location antenna 50 and a corresponding module 51, for example a GPS module, together with an antenna for the provision of connectivity with telecommunication networks, and a corresponding module 54, for example a GSM or SIGFOX or LORA module, and an antenna for the provision of local connectivity 55, together with the corresponding module 56, for example a WiFi, Bluetooth or LiFi module.

Where applicable, a single antenna can simultaneously provide connectivity with telecommunication networks and local connectivity.

The hub 20 can also comprise a wired bus 58, for example of the Ethernet or USB type.

Each tag 30 comprises, for example, a RFID chip 31 and an antenna 32, for example of the UHF dipole type.

The tag 30 can also comprise an external sensor 33 which is, for example, carried by the tag 30 or is connected to the latter, for example by a wired connection.

The sensor 33 is sensitive to at least one environmental parameter for the tag, selected, for example, from the following: temperature, humidity, acceleration, pressure, orientation, impacts, exposure to oxygen, the presence of a given gas, the presence of given analytes, exposure to light or exposure to radiation, specifically UV, IR or ionizing radiation. The sensor 33 is selected in accordance with the type of articles 10 and the nature of the monitoring to be undertaken.

The article “Passive UHF RFID Tag with Multiple Sensing Capabilities” by Jose Fernadez-Salmeron et al, Sensors 2015, 15, 26769-26782 discloses examples of tags equipped with sensors.

In variants of the deployment of the invention, all or some of the tags 30 are semi-passive, i.e. additionally comprise a cell or a battery 34, as illustrated in FIG. 7.

In the variant illustrated in FIG. 8, the tag does not comprise a specific sensor, but an antenna 32 which is functionalized, in other words, the tuning of which varies according to an environmental parameter. This variation may be detected by the hub 20 in conjunction with reading, such that the tag 30 can notify the latter of the environmental parameter. The article “Inlset—Printed Humidity Sensor For Passive UHF RFID Systems, by Tulra Virtanen et al. IEEE Transactions on Instrumentation and Measurement, Vol. 60, No. 8, August 2011, describes examples of tags with a functionalized antenna.

In the case of passive RFID tags 30, the hub 20 supplies energy for the activation of tags 30, thereby permitting the latter to operate.

In the case of semi-passive tags 30, the latter may transmit information when interrogated by the hub.

The presence of the hub 20 within the assembly of articles 10 permits the easier retention of the articles 10 within the range of the RFID reader 23 of the hub 20, thereby ensuring the reading of tags 30 on all the articles 10.

The presence of six antennae 21 on the respective sides of the housing of the hub 20 is conducive to the reading of tags in each of the three directions X, Y and Z. This can also permit location by pseudo-triangulation, as explained above.

The presence of the hub 20 and of at least one article 10 equipped with a tag 30 permits the monitoring of environmental conditions to which the assembly 1 is exposed during the handling and transport thereof. For example, the hub 20 periodically interrogates one or more tags 30, and permits the identification of movements in the environmental parameter over time. Upon an interrogation of a tag 30, the latter responds by transmitting its identifier, which is unique and, in the case of a tag having an external sensors 33, as illustrated in FIG. 6, information relating to the environmental parameter detected by the sensor 33. Information received may be stored in the memory 25. The history of the environmental parameter may be read upon the reception of the assembly 1 at its destination.

As a variant, data are transmitted by the hub 20 over time to an external server, for example via the telecommunications network to which the antenna 53 is dedicated, or via a local network.

Where applicable, data received from the tags 30 are associated with positional data for the hub 20, i.e. the hub 20 records not only the environmental parameters notified by the sensor or sensors of the tags 30, but also the position of the hub 20 upon the reception of this data from the tags 30. Accordingly, the hub 20 can constitute a table which simultaneously indicates the movement of one or more environmental parameters, but also the position of the assembly 1 at the time of recording of said parameters.

The hub 20 can also assume a useful role during the constitution of the assembly 1 by recording, for example progressively as the articles 10 are stacked, the identifier of the corresponding tag 30 and, where applicable, the location of the tag and the corresponding article within the assembly 1.

For the execution of this location, the hub 20 determines, for example, which of the antennae 21 fitted to its various sides will deliver the best reading signal, thereby indicating the relative positioning of the article 10, the tag of which is read relatively to the hub 20. Knowledge of the location of a given article 10 within the assembly 1 can permit the constitution of a more accurate record of the movement of environmental parameters within the assembly 1, by recording not only the value of the environmental parameter, but also the positioning of the tag and the corresponding sensor within the assembly.

It is also possible, specifically where the positioning of articles 10 in the assembly 1 is executed by automation, for the hub 20 to be notified of the position of each tag 30 as the corresponding article 10 is positioned within the assembly, wherein this information is transmitted to the hub 20, for example by means of the local network, which communicates with the antenna 55.

### EXAMPLES

### Example 1

64 boxes of an identical format are arranged on a pallet, 63 of which are identified by a RFID tag 30, and the last of which comprises the hub 20, having one antenna per side.

Constitution of the stack of boxes proceeds in accordance with a predefined order and positioning. Accordingly, each position is associated with a predefined and unique identifier. The hub 20 is positioned in the heart of the assembly.

The hub 20 incorporates, in its memory, a number of programs for the management of its operation. The operator may activate the hub via a local radio link, for example of the WiFi type, and select the appropriate program for the monitoring of goods. As a variant, the hub independently and automatically selects the appropriate program for the monitoring of goods, upon the activation thereof.

The hub then proceeds with the reading of tags, in order to confirm that all the latter can be read. If this is the case, the hub submits a SMS message by way of confirmation of this correct reading.

During the transport of goods, where an anomaly is observed on a box by the hub, in addition to the recording of said anomaly, the hub submits a SMS alert, indicating the identifier for the box concerned. The pallet, together with the boxes, may be viewed using an appropriate software, and the box concerned indicated by a flashing image or the application of a particular color.

### Example 2

The assembly is constituted as per the preceding example.

By way of a distinction from the preceding example, constitution of the stack is executed in an arbitrary manner. The hub 20 determines the position of each of the boxes by pseudo-triangulation, as a function of the power values reflected by the tags for each of the six antennae employed.

### Example 3

The assembly is constituted as per example 1, wherein the articles contained in the boxes identified by a RFID tag 30 are medicines, transported from a point A to a point C via a point B.

In this example, at least one temperature sensor 33 is incorporated in each tag. It is desirable that these medicines should not be exposed to a temperature which exceeds a certain predefined threshold S. The program for the monitoring of goods corresponding to this monitoring operation is selected. The hub 20 interrogates the tags, for example every 15 minutes.

During interrogation, the hub 20 proceeds with the reading of tags. It records data, specifically those associated with temperature, then remotely transmits information relating to the data received, by example by the submission of a SMS message. Initially, as temperature values have not exceeded the predefined threshold value S, the hub submits one or more SMS messages indicating that no abnormality has been detected.

At a certain stage in its journey, the pallet 64 is parked at point B, awaiting transport. At this point, this pallet is inadvertently subject to prolonged exposure to solar radiation and, as a result, undergoes an abnormal rise in temperature. In the course of an interrogation cycle by the hub 20, a number of boxes, the tag of which is read, exceed the predefined temperature threshold S. The hub transmits a SMS alert, specifying that X boxes out of Y are subject to a rise in temperature. It then executes the selection of the unique identifiers for the tags of each box concerned, and records this information in a memory zone of the tags concerned which is accessible in write mode, for example in the form of a code. In the example considered, the written entry on the tag is executed after temperature of the boxes concerned has dropped back below the predefined threshold value S. The duration of the overshoot by the temperature of the predefined threshold is also recorded. A code indicating that, conversely, no anomaly has been detected is also recorded in the same memory zone of the tags of articles, the environmental parameter of which has not exceeded the predefined threshold.

Upon the arrival of the pallet at its destination, at point C, an external reader is employed for the reading of tags, using a dedicated application, and recorded information is retrieved in order to confirm the absence of deterioration in each article upon reception.

Naturally, the invention is not limited to the examples described above.

Data exchanged between the hub and the tags may be encrypted or otherwise. Tags may be compliant with ISO standard 18000-6, or otherwise.

For example, geolocation of the hub 20 may be executed by means of the telecommunications network, with no GPS module, or location information is provided by an external means to the hub, via the local network.

1-42. (canceled)

43. An assembly comprising:
a plurality of articles;
passive or semi-passive RFID tags arranged on the articles, each comprising at least one unique identifier, in particular recorded in a non-rewritable memory, the tag being configured to transmit, when interrogated, at least the unique identifier of the tag; and
a hub comprising at least one RFID reader, present within the articles, with articles arranged on either side of the hub along at least two directions of an orthonormal reference frame associated with the hub, the latter being arranged in such a way as to be able, by means of at least one reading antenna, to interrogate at least the RFID tags of articles arranged in said directions, the hub being configured to receive data from the interrogated RFID tags.

44. An assembly comprising:
a plurality of articles;
passive or semi-passive RFID tags arranged on the articles, each comprising at least one unique identifier, in particular recorded in a non-rewritable memory, the tag being configured to transmit, when interrogated, at least the unique identifier of the tag; and
a hub comprising at least one RFID reader, present within the articles, with articles arranged on either side of the hub along at least one direction of an orthonormal reference frame associated with the hub, the latter being arranged in such a way as to be able, by means of at least one reading antenna, to interrogate at least the RFID tags of articles arranged in said direction, the hub being configured to receive data from the interrogated RFID tags,
wherein the hub is arranged for the recording of data transmitted by the RFID tags.

45. The assembly as claimed in claim 44, wherein data transmitted by the tag result from a functionalization of an antenna of the tag, such that said antenna is rendered sensitive to said environmental parameter.

46. The assembly as claimed in claim 44, wherein the hub is configured for storing in the tags information associated with data received, specifically at least one item of information associated with the environment of the latter, specifically the variation of at least one environmental parameter.

47. The assembly as claimed in claim 44, wherein the hub is configured to select tags according to their unique identifiers, in order to permit the logging of those in which the representative data for at least one environmental parameter has breached a predefined threshold.

48. The assembly as claimed in claim 43, wherein the hub is configured to record information associated with the environmental parameter in tags, the representative data for at least one environmental parameter of which has breached a predefined threshold.

49. The assembly as claimed in claim 48, wherein information is recorded in a memory zone of the tag, which is accessible in write mode, specifically in the form of a code indicating that the representative data for the environmental parameter has exceeded the predefined threshold, specifically a binary value of 0 or 1, wherein the code can additionally contain a value corresponding to the duration of the overshoot of the predefined threshold value by the representative data for the environmental parameter.

50. The assembly as claimed in claim 44, wherein the hub is of identical dimensions to the articles, or a multiple thereof, in order to permit the stacking of the hub together with the articles.

51. The assembly as claimed in claim 43, wherein the hub is designed to record data transmitted by the RFID tags.

52. The assembly as claimed in claim 44, wherein the RFID tags are UHF tags, each of which preferably has a dipole antenna.

53. The assembly as claimed in claim 44, wherein the hub, specifically in the presence of semi-passive tags, is designed, in common with the latter, to permit data exchanges between the hub and the tags, in order to modify the manner in which the latter operate, and specifically for the reprogramming thereof.

54. A method for monitoring conditions of storage and/or transport to which articles are exposed in an assembly as claimed in claim 44, wherein RFID tags are interrogated by means of said reader, wherein the hub transmits and/or stores an alert on a tag, where it loses contact with an article for a predefined period.

55. The method as claimed in claim 54, wherein the hub executes the storage in tags of information associated with data received further to interrogation, specifically at least one item of information associated with the monitoring of a predefined parameter, specifically the variation of at least one environmental parameter.

56. The method as claimed in claim 54, wherein the hub selects tags according to their unique identifiers, in order to log those in which the representative data for at least one environmental parameter has breached a predefined threshold.

57. The method as claimed in claim 54, wherein the hub records information associated with the environmental parameter in tags, the representative data for at least one environmental parameter of which has breached a predefined threshold, specifically on the fly, further to the interrogation of each tag, or only once all the tags have been interrogated.

58. The method as claimed in claim 54, wherein the hub records information indicating that, conversely, no anomaly has been detected in the same memory zone of the tags of articles, the environmental parameter of which has not exceeded the predefined threshold.

59. A packaging method for the constitution of an assembly as defined in claim 44, comprising the following steps:
the stacking of a plurality of articles, each of which carries a RFID tag, each incorporating a unique identifier in its memory; and
the provision within the plurality of articles, specifically at the center thereof, of a hub incorporating a RFID reader which is configured to read the tags on the stacked articles, wherein the hub incorporates, it its memory, an information file on the position of articles within the assembly, together with identifiers for the corresponding tags.

60. The method as claimed in claim 59, wherein the hub is not aware in advance of the identifiers of articles according to their position within the stack, and this information is only transmitted to the hub during, or upon the completion of the packaging process, specifically once all the articles are in place.

61. The method as claimed in claim 59, wherein the hub receives, during the construction of the stack, information by way of notification of the identifier for the tag of the article which is in the course of positioning, together with its location within the assembly, where applicable.

62. The method as claimed in claim 59, wherein the hub is configured such that it independently determines, for example by the use of a plurality of antennae, the location of a tag and of the associated article within the stack, by pseudo-triangulation.
